(19) United States
(12) Patent Application Publication
(10) Pub. No.: US 2022/0288710 A1
(43) Pub. Date: Sep. 15, 2022

(54) MACHINE TOOL FOR THE MACHINING OF ROTARY PARTS WITH GROOVE-LIKE PROFILES BY A GENERATING METHOD

(71) Applicant: REISHAUER AG, Wallisellen (CH)

(72) Inventors: Roger KIRSCH, Karlsbad (DE); Michael MROS, Weingarten (DE); Michel MÜLLER, Uster (CH); Erwin SENNHAUSER, Kleinandelfingen (CH)

(73) Assignee: REISHAUER AG, Wallisellen (CH)

(21) Appl. No.: 17/625,559

(22) PCT Filed: Jul. 6, 2020
(86) PCT No.: PCT/EP2020/068945

§ 371 Date: Jan. 7, 2022

(30) Foreign Application Priority Data
Jul. 17, 2019 (CH) 00918/19

(51) Int. Cl. B23F 5/16; B23Q 1/62

(52) U.S. Cl. CPC B23F 5/163; B23Q 1/625

(57) ABSTRACT

A machine tool is designed for the machining of rotary parts with groove-shaped profiles, in particular gears, by a generating method. On the one hand, a Y slide (200) is arranged on a machine bed (100), the Y slide being displaceable along a Y direction and carrying a workpiece spindle (210). The workpiece spindle drives a workpiece (220) to rotate about a workpiece axis (C). On the other hand, a Z slide (300) is arranged on the machine bed. The Z slide is arranged along a Z direction running parallel to a center plane (E1) spanned by the Y direction and the workpiece axis. An X slide (310) is arranged on the Z slide and can be displaced along an X direction relative to the Z slide (300). The X direction is perpendicular to the center plane. A tool spindle (320) is arranged on the X slide, which drives a tool to rotate about a tool axis. The tool spindle can be swiveled relative to the X slide in a swivel plane (E2), which runs parallel to the center plane, about a swivel axis (A).

### TECHNICAL FIELD

The present invention relates to a machine tool which is specially configured for the machining of groove-shaped profiles on rotary parts by a generating method and in particular for the machining by a generating method using gear-shaped tools. The term “machining by a generating method” is used here to refer to all processes in which the tool and workpiece carry out a generating (rolling) movement on each other, including all processes which are occasionally referred to in the technical literature as “crossed axes generation”. The groove-shaped profiles can in particular form a toothing. The machine tool may be configured in particular to perform a gear skiving process. The present invention also relates to a process for operating such a machine tool.

### PRIOR ART

In modern production technology, gear skiving (also referred to as hob peeling) is becoming increasingly important for the machining of rotary parts with groove-shaped profiles. Gear skiving has been known as a gear machining process since at least 1910. An early description of the process can be found in DE 243514 C. The gear skiving process is a continuous metal-cutting process for the manufacture of axially symmetrical periodic structures, using gear-shaped tools. The teeth of these tools have cutting edges on their end faces. The tool and the workpiece are mounted on rotary spindles. The axes of rotation of tool and workpiece are arranged skewed to each other. By coupling the rotary movements of tool and workpiece around the axes of rotation, the typical rolling movement is realized. This rolling movement and a feed movement of the tool or the workpiece along the workpiece axis generate a cutting movement during gear skiving. Both external and internal gears can be machined with this cutting process.

A gear skiving machine often has six driven, numerically controlled axes to generate the rotary motions of the workpiece and tool as well as to position and orient the workpiece and tool relative to each other. The designations of these axes vary depending on the convention used. The following convention is used in this document:
Swivel axis for the relative orientation of tool spindle and workpiece spindle to each other: A axis:
rotation axis of the gear skiving tool on the tool spindle: tool axis or B axis;
rotation axis of the workpiece on the workpiece spindle: workpiece axis or C axis; and
three linearly independent, but not necessarily perpendicular, linear displacement axes for the relative positioning of the tool spindle and the work spindle to each other: X, Y and Z axes.

From the state of the art, a wide range of possibilities for the design and arrangement of these axes are known. These possibilities differ first of all with regard to the orientation of workpiece axis and tool axis in space. The workpiece axis, for example, can have a fixed orientation in space or can be swiveled. If the workpiece axis has a fixed orientation in space, it can be aligned horizontally or vertically in space. Depending on whether or not the workpiece axis can be swiveled, the tool axis can have a fixed orientation in space or can be swiveled. If the tool axis has a fixed orientation, this axis can also be aligned vertically or horizontally. These different ways of orienting the workpiece and tool axes lead, among other things, to different operating concepts for loading and unloading of workpieces and to different requirements for chip removal. For each of these variants, there are again a large number of possibilities regarding the arrangement of the different axes relative to the machine bed and relative to each other and regarding the realization of the axes.

An example of a gear skiving machine with horizontal arrangements of the workpiece and tool spindle is the GS300H machine from JTEKT Corporation, Nagoya, Japan (see brochure “Gear Skiving Centers/Machining Centers Line Up”, catalog no. M2027-7E, imprint 170325U). On the tool carrier, the tool spindle is fed radially by means of a vertical slide and the entire tool carrier can be moved horizontally. The tool spindle runs horizontally in space and has a fixed orientation. The workpiece carrier, on a horizontal slide, realizes the axial infeed. The workpiece spindle also runs horizontally in space and can be swiveled around a vertical swivel axis in a horizontal swivel plane.

A machine with a similar tool carrier is also known from US20150043985A1. In this machine, however, the workpiece spindle can be swiveled around a horizontal axis in a vertical swivel plane.

However, the far greater number of gear skiving machines have a vertically oriented workpiece axis and a swiveling tool axis. For example, on the LK 300 and LK 500 gear skiving machines from Liebherr Verzahntechnik GmbH, Kempten, Germany, the workpiece spindle is vertically aligned and fixed to the machine bed, while the tool spindle is located above the workpiece spindle and can be moved relative to the machine bed along all three linear displacement axes X, Y and Z and swiveled about an A axis (cf. Brochure “Gear Skiving Machines LK 300/500”, Liebherr-Verzahntechnik GmbH, imprint BK LVT-LK300/500-1.0.-07.18_en).

Also on the 400HP machine from Gleason Corporation, Rochester. USA, the workpiece spindle is vertically aligned and fixed to the machine bed. Such an arrangement is also known from US2017072485A1, FIG. 11. The MSS300 machine from Mitsubishi Heavy Industries Machine Tool Co. Ltd, Shiga, Japan also features a fixed, vertical work spindle. Such an arrangement is also known from US2019076943A1, FIG. 1.

On the S-250 machine from Profilator GmbH & Co KG, Wuppertal, Germany, the tool spindle is mounted on a slide in such a manner that it can be swivelled around the A axis, and this slide can in turn be moved relative to the machine bed along a linear displacement axis, which is inclined relative to the machine bed. The workpiece spindle can be moved above the tool spindle along two linear displacement axes. On the S-500 machine from Profilator GmbH & Co KG, too, the workpiece spindle can be moved above the tool spindle along two linear displacement axes (see lecture notes by Dr. Claus Kobialka, “Stand der Technik zum Wälzschälen (SCUDDING)” [“State of the art in gear skiving (SCUDDING)” ], GETPRO Kongress, Mar. 25 and 26, 2015, Würzburg, Germany).

A tool spindle arranged at the bottom, which can be swiveled, is also present in the “SynchroSkiver” machine from Präwema Antriebstechnik GmbH, Eschwege, Germany. Here, too, the workpiece spindle can be linearly displaced above the tool spindle along two axes (see brochure “SynchroSkiver”, Präwema Antriebstechnik GmbH, imprint PRW-2015-09-V1-HDM).

The KPS20 machine from Kashifuji KK also features a swiveling tool spindle, above which the workpiece spindle can be moved along two axes. An arrangement with a swiveling tool spindle at the bottom and a workpiece spindle that can be moved above it is also known from JP2014151382A2, FIG. 1.

Another concept with a swiveling tool spindle at the bottom and a crosswise movable workpiece spindle above it is also known from US2012328384A1 (FIG. 18).

On the GMS450 machine from Nachi-Fujikoshi Corp., Toyama. Japan, the workpiece spindle is vertically aligned and can be moved horizontally along one direction relative to the machine bed. On a machine stand, which is firmly connected to the machine bed, a slide above the workpiece spindle can be moved horizontally perpendicular to the direction of movement of the workpiece spindle. On this slide, a vertically displaceable carriage is mounted. The tool spindle is mounted on this slide so that it can swivel around an A axis. The A axis runs parallel to the axis along which the work spindle can be moved on the machine bed. Reference is made to document “GMS450” issued by Nachi-Fujikoshi Corp., Catalog No. M6202E, imprint 2016.9.X.MD-SANWA.

Also on the PV315 machine from Pittler T & S GmbH, Dietzenbach, Germany, the workpiece spindle is vertically aligned and can be moved along one direction along the machine bed. A machine column can be moved horizontally on the machine bed along a direction perpendicular to direction of movement of the workpiece spindle. The machine stand carries a vertically displaceable slide on which the tool spindle is arranged so that it can be swiveled in a swivel plane parallel to the horizontal displacement direction. Reference is made to the document “Wälzschälen in der Komplettbearbeitung” [“Gear skiving in total machining” ] from PITTLER T&S GmbH, imprint PIT-2017.04-EN-HDM.

Due to the special kinematics during gear skiving, machining forces vary considerably along the cutting edge contact. This is particularly true for the hard fine machining of pre-toothed workpieces. In particular, high and strongly fluctuating axial forces are generated along the tool and workpiece axes on the one hand; on the other hand, high and strongly fluctuating radial forces are also generated, which lead to large bending moments on the tool and workpiece. All in all, these process characteristics have a negative effect on the achievable manufacturing accuracy, especially if the respective NC axes are moved during the machining process. Important factors for achieving high manufacturing accuracy are in particular the static and dynamic rigidity, the damping properties of the machine and a high thermal symmetry. However, these requirements are not yet optimally met by the existing arrangements.

### SUMMARY OF THE INVENTION

It is an object of the present invention to provide a machine tool which is suitable for the machining by a generating method, in particular gear skiving, of rotary parts with groove-shaped profiles, in particular gears, and in particular for their hard fine machining, and which exhibits improved static and dynamic stiffness combined with high thermal stability.

This object is achieved by a machine tool with the characteristics of claim 1. Further embodiments are provided in the dependent claims.

A machine tool for the machining of rotary parts with groove-shaped profiles by a generating method is provided. The machine tool comprises:
a machine bed;
a Y slide, which is linearly displaceable along a Y direction relative to the machine bed;
a workpiece spindle which is arranged on the Y slide and which is configured to clamp a workpiece on it and to drive it to rotate about a workpiece axis (C axis), the workpiece axis extending transversely, preferably perpendicularly, to the Y direction;
a Z slide which is arranged on the machine bed and is linearly displaceable along a Z direction relative to the machine bed, the Z direction extending parallel to a center plane defined by the Y direction and the workpiece axis, and the Z direction extending at an angle of less than 45°, preferably parallel to the workpiece axis;
an X slide mounted on the Z slide, the X slide being linearly displaceable along an X direction relative to the Z slide, the X direction being perpendicular to the center plane; and
a tool spindle which is configured to clamp a generating machining tool, in particular a gear-shaped generating machining tool, on it and to drive it to rotate about a tool axis (B axis), the tool spindle being arranged on the X slide and being pivotable relative to the X slide about a first swivel axis (A axis).

In this document, two axes are to be understood to extend “transverse” to each other if the two axes are at an angle of more than 45° and less than 135° to each other, in particular at an angle of more than 60° and less than 120°.

Since the entire X slide including the tool spindle and its swivel mechanism is located on the Z slide, the inertial mass on the Z slide is relatively large. This is particularly advantageous because machining forces acting along the main cutting direction are mainly introduced in the Z direction, and therefore particularly large and strongly fluctuating machining forces and tilting loads occur along this direction. Due to the large inertial mass on the Z slide, a particularly advantageous dynamic behavior is achieved along the Z direction, which is subject to particularly high loads. In addition, the design with a center plane, relative to which the axes are aligned, enables a particularly rigid and thermally stable construction. Finally, the relatively light-weight (low-mass) Y slide, which is independently guided on the machine bed, makes it possible to move the workpiece spindle quickly and precisely along the Y axis between a workpiece change position and a machining position.

In advantageous embodiments, the first swivel axis (A axis), about which the tool spindle is pivotable relative to the X slide, extends perpendicularly to the center plane, and the tool axis extends perpendicularly to the first swivel axis. In this case, the swivel movement of the tool axis takes place in a swivel plane that is parallel to the center plane and thus reflects the symmetry of the rest of the machine structure. In addition, the tool axis preferably intersects the first swivel axis so that torques around the A axis are minimized.

This arrangement of the swivel plane parallel to the center plane is particularly advantageous for gear machining processes in which gear-shaped tools are used, such as for gear skiving or gear shaving. However, an arrangement of the first swivel axis (A axis) parallel to the center plane and in particular perpendicular to the X and Z axes is also conceivable; also then the tool axis is advantageously perpendicular to the first swivel axis (A axis) and in particular intersects the first swivel axis. Such an arrangement can be advantageous in particular for generating machining processes with worm-shaped tools such as generating gear grinding or hobbing.

In advantageous embodiments, the tool spindle is arranged to swivel on the X slide as follows: The machine tool has two first swivel bearings to support the tool spindle on the X slide about the first swivel axis. These first two swivel bearings are arranged on both sides of the tool spindle with respect to the swivel plane and preferably equidistant from the swivel plane.

The machine tool may comprise an adjustment mechanism for adjusting the orientation of the tool spindle relative to the X slide. This adjustment mechanism may be pivotally connected to the X slide about a second swivel axis, the second swivel axis being parallel to and spaced apart from the first swivel axis, and may also be pivotally connected to the tool spindle about a third swivel axis, the third swivel axis being parallel to and spaced apart from the first swivel axis and the second swivel axis. In this case, there are therefore a total of three swivel axes through which the X slide, the tool spindle and the adjustment mechanism are connected to each other.

The adjustment mechanism can also be advantageously supported on both sides of the swivel plane. For this purpose, the machine tool can comprise two second swivel bearings for supporting the adjustment mechanism on the X slide about the second swivel axis, the two second swivel bearings being arranged on both sides and preferably equidistant from the swivel plane, and/or it can comprise two third swivel bearings for supporting the adjustment mechanism on the tool spindle about the third swivel axis, the two third swivel bearings likewise being arranged on both sides and preferably equidistant from the swivel plane.

In particular, the adjustment mechanism may be of the following design: It may comprise an A drive motor which is pivotable relative to the X slide and drives a threaded spindle to rotate about a threaded spindle axis extending perpendicularly to the first swivel axis, the threaded spindle axis extending in the swivel plane. It may also comprise a spindle nut that is pivotable relative to the X slide and engages with the threaded spindle. In particular, the threaded spindle and the spindle nut can be configured as a ball screw drive. This type of mechanism, with its high transmission ratio, allows a particularly safe, rigid, precise and smooth adjustment of the orientation of the tool spindle about the first swivel axis (A axis). The adjustment can even take place during the machining of a workpiece; clamping for stationary operation is not necessary.

Preferably, the A drive motor is pivotably mounted on the X slide so that it can swivel about the second swivel axis, and the spindle nut is connected to the tool spindle so that it can swivel about the third swivel axis. However, an inverse arrangement is also conceivable in which the A drive motor is connected to the tool spindle so that it can swivel about the third swivel axis and the spindle nut is connected to the X slide so that it can swivel about the second swivel axis.

In order to precisely determine the swivel position of the workpiece spindle, the machine tool can comprise:
a first angle measuring device configured to determine an angle of rotation of the A drive motor or threaded spindle about the threaded spindle axis; and/or
at least one second angle measuring device configured to directly determine a swivel angle of the tool spindle about the A axis relative to the X slide.

A particularly advantageous arrangement of the adjustment mechanism is as follows: The tool spindle has one end facing the tool (tool end) and one end facing away from the tool (drive end). At the tool end, a generating machining tool is clamped on the tool spindle, which defines a tool reference plane extending perpendicular to the tool axis. In the case of a gear skiving tool, the tool reference plane can be, in particular, a plane that extends through the cutting edges of the tool at the distal end of the tool (“cutting edge plane”). In the case of other types of generating machining tools (e.g. hobs or generating grinding tools), the tool reference plane can generally be any plane of action perpendicular to the tool axis in which the tool interacts with the workpiece during machining. There may be a whole set of such planes on the tool, but usually the range along the tool axis where these planes intersect the tool axis is small compared to the length of the entire tool spindle, so the concrete position of the tool reference plane is not important for the following considerations. For example, the tool reference plane can be assumed to be a plane through the center of that portion of the tool along the B axis that is intended for machining. The first tilting axis (A axis) intersects the tool axis (B axis) between the end of the tool spindle that faces the tool and the end that faces away from the tool. The connection between the tool spindle and the adjustment mechanism is made in the region of the end of the tool spindle that faces away from the tool, i.e. the third swivel axis is in the region of this end facing away from the tool. The first swivel axis (A axis) and the tool reference plane are at a first distance from each other, and the A axis and the third swivel axis are at a second distance from each other. It is advantageous if the second distance and the first distance have a ratio greater than 1, preferably a ratio of 1.5 to 3.

In this arrangement, the A-axis therefore intersects the tool axis near the tool-side spindle end. This results in very short lever arms for the forces acting on the tool in the X, Y and Z directions, which can have a pulsating characteristic due to the machining process. These forces therefore act on the machine structure with relatively low bending moments and thus generate a relatively low vibration energy that can act on the tool carrier. The large mass of the entire tool carrier also provides effective broadband damping. Furthermore, the movement of the tool in the Y and Z directions caused by the swivel movement around the A axis is small due to the minimized distance of the tool reference plane to the swivel axis.

For adjusting the orientation of the tool spindle around the A axis, other adjustment mechanisms can be used instead of the threaded adjustment mechanism discussed above, especially a direct drive with torque motor. Although a direct drive is advantageous in terms of a simple design, it is located in the machining area and takes up a lot of space in it. This results in additional collision restrictions between tool and workpiece. In addition, the large space requirement of a direct drive can lead to the fact that on the one hand the X slide must be designed wider and thus ultimately the machine as a whole becomes wider, and that on the other hand the A axis must have a greater distance to the X and Z guides, so that the forces described above act on the tool via larger lever arms on the machine structure, with correspondingly negative consequences for the tendency to vibrate. The version with screw drive discussed above avoids these disadvantages.

In order to additionally dampen vibrations of the tool spindle around the A axis, the machine tool may have at least one vibration damper, preferably two vibration dampers arranged on both sides and preferably equidistant from the swivel plane, the vibration damper or dampers acting between the tool spindle and the X slide.

The swivel range of the tool spindle about the first swivel axis (A axis) is preferably asymmetrical, i.e. the tool spindle can preferably be swiveled about the A axis in relation to the X slide in such a way that an axis crossing angle between the tool axis (B axis) and the workpiece axis (C axis) takes on either negative or positive values, the maximum positive value of the axis crossing angle being greater than the magnitude (absolute value) of the smallest negative value. The magnitude of the smallest negative value is preferably not greater than 10°, while the maximum positive value is preferably at least 30°. The axis crossing angle is defined as positive when the tool is inclined toward the X slide and negative when the tool is inclined away from the X slide. The asymmetrical swivel range means that less space is required, and the work spindle or the A axis can be positioned closer to the linear guides of the Z and X slides in order to keep the effective lever arm short with respect to torsion around these linear guides. In addition, the tool center is located closer to the linear guides of the Z and X slides than the A axis when the axis crossing angle is positive, which has an additional positive effect on machining precision. Due to the symmetrical design of the machine with respect to the center plane, an asymmetrical swivel range does not mean a restriction for generating machining, because depending on the direction of the helix angle of the gear to be machined, the tool can be brought into engagement with the gear to be machined during gear skiving by moving the X slide either to the left or right of the center plane. The symmetry of the arrangement of the linear axes with respect to the swivel plane is not affected by the asymmetrical swivel range.

In some embodiments, the workpiece axis (C axis) runs vertically in space. This enables easy workpiece change and efficient chip removal. In addition, if the C-axis is arranged vertically, the Z-direction preferably also runs vertically in space. In such an arrangement, the weight of the Z slide, together with the X slide mounted on it and the tool spindle, acts along the Z direction, thus further reducing the tendency to vibrate along the Z direction. It is also possible, however, that the C axis runs along a different spatial direction, in particular, horizontally.

The machine tool preferably comprises two parallel Z linear guides which extend parallel to the Z direction, are arranged on both sides and preferably equidistant from the aforementioned center plane and on which the Z slide is guided along the Z direction relative to the machine bed. A separate Z drive can then be assigned to each of the linear guides to move the Z slide along the Z direction relative to the machine bed. In particular, each of these Z drives can include a drive motor, a threaded spindle and an associated spindle nut. The threaded spindle and spindle nut are preferably configured as a ball screw drive. Such a double Z drive contributes to a high dynamic rigidity and maintains the symmetry in the machine tool structure with respect to the center plane.

To precisely determine the Z position of the workpiece spindle, the machine tool may comprise one, preferably two Z linear measuring systems, each of the Z linear measuring systems comprising a measuring head mounted on the Z slide and a linear scale mounted on the machine bed. The measuring head of each of the Z linear measuring systems is then preferably arranged to perform a position measurement in an A reference plane that extends perpendicular to the Z direction and contains the A axis. Thus, the measurement is carried out at a defined location that is very well suited for characterizing the position of the workpiece spindle.

To guide the X slide on the Z slide, the machine tool preferably comprises two X linear guides which are parallel to each other, extending parallel to the X direction, and on which the X slide is guided along the X direction relative to the Z slide. A single X drive may be provided for the X axis, which may in particular comprise a drive motor, a threaded spindle and an associated spindle nut. The threaded spindle and spindle nut are preferably configured as a ball screw drive. However, a double drive is also conceivable here, as indicated above for the Z direction.

The guidance of the Y slide on the machine bed can be done in a very similar way to the guidance of the Z slide. In particular, the machine tool can comprise two parallel Y linear guides that extend parallel to the Y direction, are arranged on both sides and preferably equidistant from the center plane, and on which the Y slide is guided along the Y direction relative to the machine bed. The machine tool can in turn have two Y drives to move the Y slide along the Y direction relative to the machine bed, one of the Y drives being assigned to each of the Y linear guides. Each of the Y drives can comprise a drive motor, a threaded spindle and an associated spindle nut. The threaded spindle and spindle nut are preferably configured as a ball screw drive.

Similar to the Z axis, the machine tool may comprise one, preferably two Y linear measuring systems, each of the Y linear measuring systems comprising a measuring head mounted on the Y slide and a linear scale mounted on the machine bed. Each of the measuring heads of the Y linear measuring systems is preferably arranged in such a way that it performs a position measurement in a C reference plane which is perpendicular to the Y direction and contains the workpiece axis (C axis). In this way the measurement is performed at a location that characterizes the position of the workpiece center with respect to the Y direction particularly well.

Due to the paired drives in the Y and Z axes, the stiffness is improved both against axial movements along the respective direction and against tilting movements around the Y and Z direction.

The machine tool may comprise at least one of the following additional components.
a meshing device for determining a position of tooth gaps of the workpiece;
an optical measuring bridge for measuring the tool and/or the workpiece; and
a tool changing device for changing the tool.

For each of the additional components, two alternative mounting structures can be provided, which are arranged on both sides of the center plane. In particular, two alternative mounting structures for the meshing probe can be formed on the X slide on both sides of the center plane. On the Y slide, two alternative mounting structures for the measuring bridge can be formed on both sides of the center plane. Two alternative mounting structures for the tool change device can be formed on the machine bed on both sides of the center plane. In this way, a workpiece loader can be placed in one of several possible locations, depending on the customer's requirements, and the additional components can then be attached to the machine in such a way that they do not collide with the workpiece loader. In the simplest case, each of the fastening structures can include, for example, a fastening surface with suitable bores. In more complex embodiments, a fastening structure can include a three-dimensional structure that is specifically configured for the attachment of the respective additional component.

The machine tool may comprise a chip conveyor located in the center plane below the machine bed. The machine bed may have a central opening to allow chips to drop from a machining zone onto the chip conveyor. The chip conveyor may preferably be arranged to convey chips from a machining area at the front of the machine to a rear area of the machine. Alternatively, however, it is also conceivable to convey the chips in the direction of the front of the machine.

The machine tool is configured specifically for the machining of rotary parts with groove-shaped profiles, especially gears, by a generating method. For this purpose, the machine tool comprises a controller that is configured to establish a positive coupling between the rotation of the generating machining tool and the rotation of the workpiece. The machine can be used for soft machining, but preferably it is used for hard fine machining of pre-toothed workpieces. The machine tool is particularly suitable for gear skiving, but can also be used for other generating methods, especially for gear shaving, gear honing, generating gear grinding or hobbing.

A method of machining a workpiece with a machine tool of the above type comprises:
bringing a generating machining tool clamped on the tool spindle into engagement with the workpiece while the workpiece is clamped on the workpiece spindle, the engagement preferably taking place in an arrangement of the generating machining tool relative to the workpiece in which the tool axis extends offset to the center plane of the machine tool; and
carrying out a generating machining method on the workpiece with the machine tool.

In particular, the generating machining tool can be a gear-shaped generating machining tool, e.g. a gear skiving tool.

### BRIEF DESCRIPTION OF THE DRAWINGS

Preferred embodiments of the invention are described in the following with reference to the drawings, which are for explanatory purposes only and are not to be interpreted as limited. In the drawings:

FIG. 1 shows a perspective view of a machine tool according to a first embodiment:

FIG. 2 shows an enlarged detailed view in area A1 in FIG. 1;

FIG. 3 shows a sectional view of the machine tool in FIG. 1 in the center plane E1;

FIG. 4 shows an enlarged detailed view in area A2 in FIG. 3;

FIG. 5 shows a perspective view of the machine tool in FIG. 1, leaving out parts in the area of the X slide; and

FIG. 6 shows a perspective view of a machine tool according to a second embodiment.

### DESCRIPTION OF PREFERRED EMBODIMENTS

### First Embodiment: Vertical Workpiece Axis

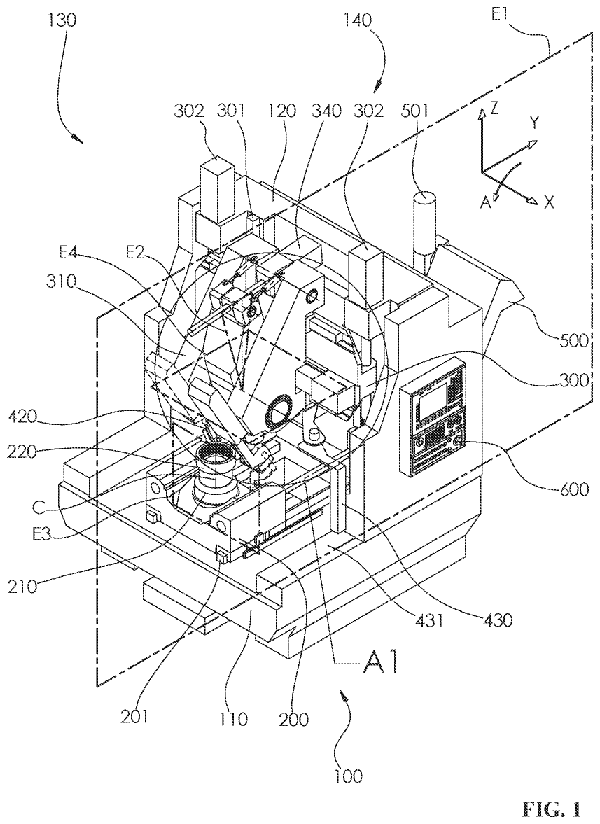

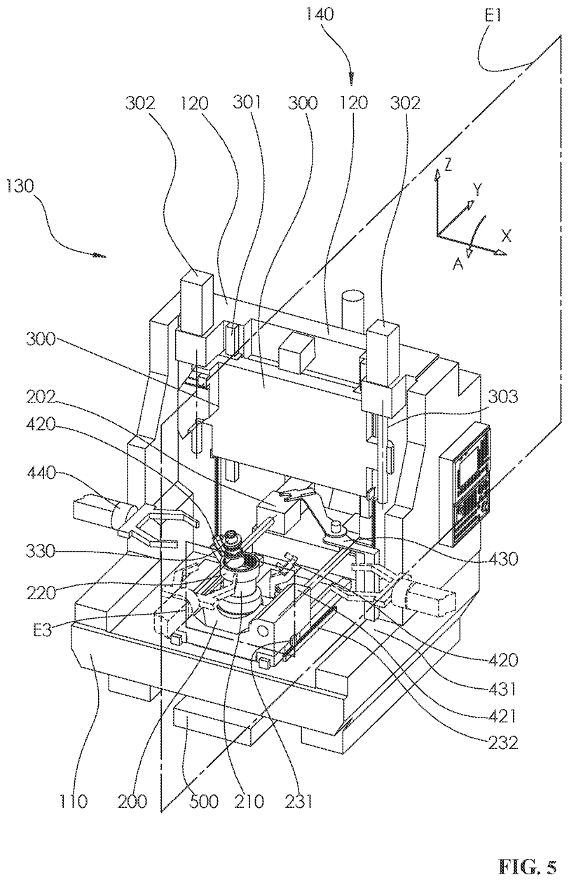

FIGS. 1 to 4 show in different views a machine tool according to a first embodiment. In FIG. 5, parts of the machine are not shown for better visibility, especially the front part of the Z slide and the entire X slide with the tool spindle mounted on it.

The illustrated machine tool is a machine which is particularly suitable for gear skiving. However, it is also possible to carry out other types of machining processes with such a machine, especially other generating machining processes.

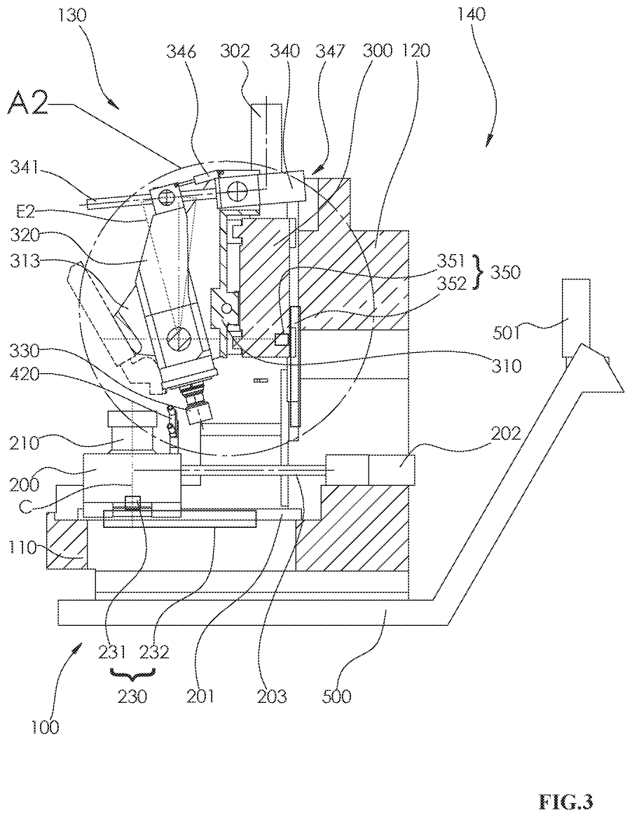

The machine comprises a machine bed 100. As can best be seen in FIG. 3, the machine bed 100 is approximately L-shaped in a side elevation, having a horizontal portion 110 and a vertical portion 120. The vertical portion of the machine bed 120 separates a front machining area 130 from a rear area 140 of the machine.

A Y slide 200 is arranged on the horizontal portion 110 of the machine bed 100. The Y slide can be displaced along a Y direction relative to the machine bed 100. The Y direction runs horizontally in space. The Y slide 200 carries a workpiece spindle 210, on which a pre-toothed workpiece 220 is clamped. The Y slide 200 thus serves as a workpiece carrier. The workpiece 220 is driven on the workpiece spindle 210 so that it can rotate about a workpiece axis (C axis). The C axis runs vertically in space, i.e. along the direction of gravity. The C axis and the Y direction together span a center plane E1 of the machine. The center plane E1 contains the C axis, independent of the position of the Y slide 200 along the Y direction.

A Z slide 300 is arranged on the vertical portion 120 of the machine bed 100. The Z slide can be moved along a Z direction relative to the machine bed 100. The Z direction is parallel to the center plane E1. In the present example, the Z direction runs vertically in space, parallel to the C axis and perpendicular to the Y direction. An X slide 310 is arranged on the Z slide 300, the X slide carrying a tool spindle 320 and thus forming a tool carrier. The X slide 310 can be displaced along an X direction relative to the Z slide 300. The X direction runs horizontally in space, perpendicular to the Z direction and the Y direction and thus perpendicular to the center plane E1. Together, the Z slide 300 and the X slide 310 form a compound slide rest that enables the tool spindle 320 mounted on it to be moved along the Z and X directions, which are perpendicular to each other.

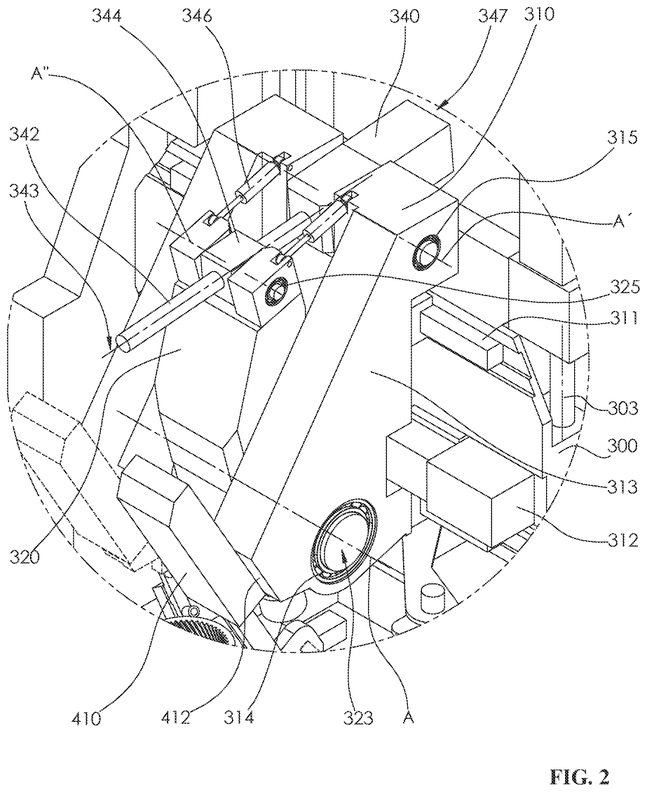

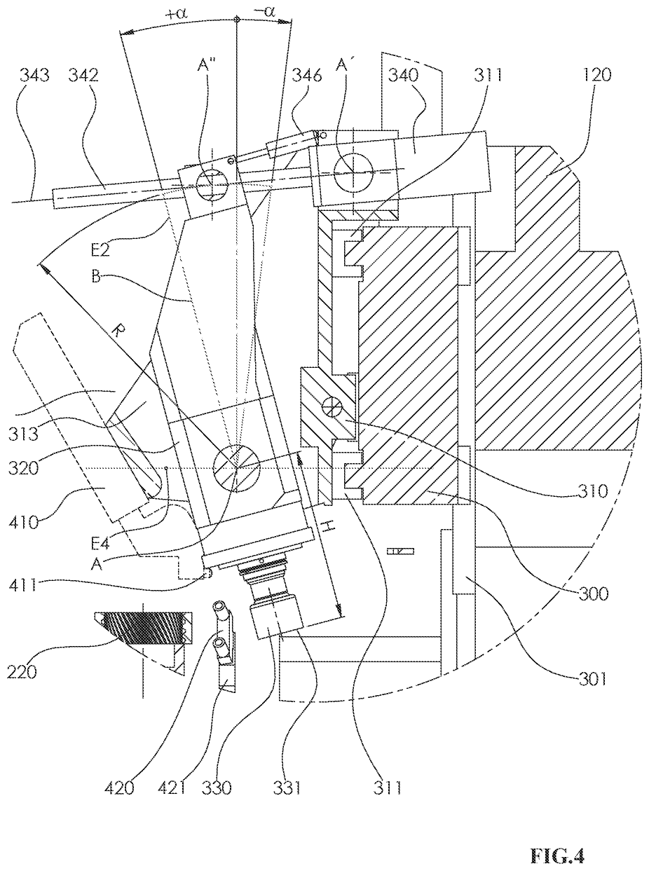

The tool spindle 320 drives a generating machining tool mounted on it, in the present case a gear skiving tool 330 (“hob peeling wheel”, see FIGS. 3 and 4), to rotate about a tool axis (B axis, see FIG. 4). The tool spindle 320 can be swiveled about a first swivel axis (A axis, see FIG. 2) in relation to the X slide 310. The A axis is perpendicular to the B axis and perpendicular to the center plane E1. The A axis intersects the B axis. The plane in which the B axis swivels is referred to as the swivel plane E2. This swivel plane E2 is perpendicular to the A axis (i.e. it is a normal plane to the A axis) and contains the B axis, regardless of its swivel position about the A axis. It is parallel to the center plane E1.

A chip conveyor 500 is arranged below and behind the machine bed 100 in such a way that it conveys chips from an area below the Y slide 200 to the rear area 140 of the machine. The chip conveyor 500 has a drive 510 for this purpose. Below the Y slide 200, an opening is arranged in the machine bed 100 for the discharge of the chips produced. Alternatively, the chip conveyor 500 can be arranged so that it conveys the chips to the front instead of to the rear.

A machine controller with control panel 600 is used to control and operate the machine.

### Setting the Orientation of the Tool Spindle Around the A Axis

When carrying out generating machining operations, it is important that the orientation of the tool spindle 320 about the A axis can be precisely adjusted. For this purpose, the machine is equipped with an appropriate adjustment mechanism.

FIGS. 2 and 4 show the swivel-mounted tool spindle 320 and the adjustment mechanism for adjusting the orientation of the tool spindle 320 around the A axis. The X slide 310 has a side wall (“cheek”) 313 on each side of the swivel plane E2, which extends parallel to the swivel plane E2 and forwards against the Y direction. A sufficiently large recess for the tool spindle 320 is provided between the two cheeks 313. The tool spindle 320 is located between the cheeks 313 in the swivel plane E2 and is supported in the corresponding cheek 313 via a swivel bearing 314 in the form of a play-free rolling bearing. The two swivel bearings 314 enable the tool spindle 320 to swivel relative to the X slide 310 about the first swivel axis (A axis).

In an upper end area of the X slide 310, an A drive motor 340 is arranged centrally between the cheeks 313. The A drive motor is mounted on both sides of the swivel plane E2 in two play-free rolling bearings 315 so that it can swivel on the X slide 310 about a second swivel axis A′. The second swivel axis A′ runs parallel to the A axis. The A drive motor 340 drives a threaded spindle 342 to rotate about a threaded spindle axis 343. The threaded spindle 342 cooperates with a spindle nut 344. The threaded spindle 342 and the spindle nut 344 are configured as a play-free ball screw drive.

The spindle nut 344 is connected on both sides of the swivel plane E2 to an upper end section of the tool spindle 320. The spindle nut 344 can be swiveled about a third swivel axis A″ relative to the tool spindle 320 via two play-free rolling bearings 325. The third swivel axis A″ is again parallel to the A axis.

By actuating the A drive motor 340, the threaded spindle 342 is driven to rotate about the threaded spindle axis 343. This changes the position of the spindle nut 344 along the threaded spindle axis 343. This causes the tool spindle 320 to swivel about the A axis. Due to the high transmission ratio, a relatively low drive torque of the A drive motor 340 is converted into a relatively high displacement force or a relatively high swivel torque onto the tool spindle 320. All in all, the swivel movement of the tool spindle 320 can thus be executed very smoothly and precisely. Even during machining, it is possible to change the orientation of the tool spindle 320. Clamping for stationary operation is not necessary.

The geometrical conditions prevailing here are explained in more detail in FIG. 4. The A axis (see FIG. 2) intersects the B axis in a region that lies between the end of the tool spindle 320 that faces the tool and the end that faces away from the tool. The tool 330 has a number of cutting edges at its free end, which together define a cutting edge plane 331. This cutting edge plane 331 is a reference plane on the tool. The cutting edge plane 331 is perpendicular to the B axis. The distance of the cutting edge plane 331 from the A axis defines a lever arm H. The distance between the A axis and the third swivel axis A″, about which the spindle nut 344 can be swiveled, defines a swivel radius R.

The radial cutting forces that act between the workpiece and the tool during workpiece machining result in corresponding torques about the A axis. The torque about the A axis for a given radial cutting force in the swivel plane E2 is proportional to the length of the lever arm H. This torque in turn results in a corresponding axial force on the spindle nut 344 along threaded spindle axis 343. This force is smaller the larger the swivel radius R. In the present case, the swivel radius R is significantly larger than the lever arm H. Preferably, the ratio R/H is larger than 1 and lies in particular between 1.5 and 3. The A drive motor 340 therefore only needs to absorb correspondingly reduced forces. This is advantageous for the rigidity of the machine with regard to vibrations about the A axis.

To dampen vibrations about the A axis, additionally two vibration dampers 346 are arranged between the tool spindle 320 and the X slide 310. These extend on both sides of the swivel plane E2 between the upper end section of the tool spindle 320 and the upper end section of the X slide 310, adjacent to threaded spindle 342.

For precise machining of the workpiece in a generating machining process such as the gear skiving process, precise knowledge of the orientation of the tool spindle 320 about the A axis, i.e. of the angle α between the B axis and the C axis (see FIG. 4), is important. The angle α is also referred to in this document as the axis crossing angle. The machine preferably features two independent angle measuring devices for precise measurement of this angle. One of the angle measuring devices measures the angle of rotation of the threaded spindle 342, this information can be used to indirectly determine the position of the spindle nut 344 along the threaded spindle 342 and therefore the tilt angle of the tool spindle 320. This first angle measuring device is integrated in the A drive motor 340 and is indicated in FIG. 2 by reference sign 347. At least one other angle measuring device measures directly the tilt angle of tool spindle 320 about the A axis and therefore the axis crossing angle α. This further angle measuring device is integrated in one of the two swivel bearings 314 and indicated by reference sign 323 (see FIG. 2).

As illustrated in FIG. 4, the axis crossing angle α can assume both positive and negative values. The axis crossing angle α is defined as positive when the tool 330 is inclined toward the X slide 310 and negative when the tool 330 is inclined away from the X slide 310. The swivel range of the tool spindle 320 is asymmetrical: The axis crossing angle α can assume significantly larger positive than negative values. Specifically, the swivel range can be from −5° to +35°, but other swivel ranges are also possible. Due to the almost mirror-symmetrical design of the machine with respect to the center plane E1, this does not mean that the generating machining process is restricted to only one helix direction of the gear to be machined, because depending on the helix direction, the tool 330 can be brought into engagement with the gear to be machined either to the left or right of the center plane E1.

### Positioning of the Tool Carrier in Z and X Direction

As already mentioned, the machine is designed in such a way that the position of the tool spindle 320 is adjustable both along the Z direction and along the X direction. The Z displacement is used for axial feed and the X displacement or a combination of X and Y displacements for radial infeed in generating machining. Since machining forces fluctuate particularly strongly along the Z direction, the adjustment along the Z direction is carried out with a Z slide 300 that is guided directly on the machine bed 100; the X slide 310 is mounted on this Z slide as a tool carrier. This means that a much greater inertial mass needs to be moved along the Z direction than along the X direction. This helps to keep the amplitude of vibrations along the Z direction, which might be excited by the fluctuating machining forces, small.

In order to guide the Z slide 300 relative to the machine bed 100, two parallel Z linear guides 301 are provided on the vertical portion 120 of the machine bed, extending parallel to the Z direction and being arranged on both sides symmetrically to the center plane E1. The Z slide 300 is guided on these linear guides 301 along the Z direction relative to the machine bed 100. Each of the linear guides 301 is assigned a Z drive motor 302. Each of these Z drive motors 302 interacts with the Z slide 300 via a play-free ball screw drive 303 to drive the Z slide 300 along the Z direction (see FIG. 5). The Z linear guides 301, Z drive motors 302 and ball screw drives 303 are each constructed almost identically in pairs and arranged symmetrically to each other with respect to the center plane E1. The two Z drive motors are either separately position-controlled (“double drive”) or work together in master-slave operation.

In order to dampen vibrations along the Z direction, each Z linear guide 301 is optionally assigned a vibration damper not shown in the drawing. This vibration damper can be configured in particular according to Swiss patent application 1023/18 of Aug. 24, 2018. The vibration dampers are also identically constructed in pairs and arranged symmetrically.

Each of the two Z linear guides 301 is assigned a Z linear measuring system 350 in order to determine the position of the Z slide 300 on the machine bed 100 as accurately as possible (see FIG. 3). The two Z linear measuring systems 350 are also identically constructed and arranged symmetrically with respect to the center plane E1. Each of these Z linear measuring systems has a measuring head 351, which is attached to an outer surface of the Z slide 300. In addition, each Z linear measuring system has a linear scale 352 attached to the machine bed 100. The measuring head 351 is mounted so that it performs a position measurement in a plane E4 that is perpendicular to the Z direction (i.e. a plane normal to the Z direction) and contains the A axis. This plane E4 is particularly suitable for characterizing the position of the A axis relative to the machine bed 100 with respect to the Z direction and is therefore also referred to as the A reference plane.

In order to guide the X slide 310 on the Z slide 300, two X linear guides 311 are provided on the Z slide 300, parallel to each other, which extend parallel to the X direction and on which the X slide 310 is guided along the X direction relative to the Z slide. An X drive motor 312 is used to adjust the position of the X slide 310 along the X direction.

### Positioning of the Workpiece Carrier in Y-Direction

The guidance and displacement of the Y slide 200 (i.e., the workpiece carrier) relative to the machine bed 100 along the Y direction is very similar to the guidance and displacement of the Z slide 300 along the Z direction. On the horizontal portion of the machine bed 100, two parallel Y linear guides 201 are arranged symmetrically to the center plane E1. The Y slide 200 runs on these linear guides 201. To drive the Y slide 200, a separate Y drive motor 202 is assigned to each of the two linear guides 201 (see FIG. 3). Each of the Y drive motors 202 interacts with the Y slide 200 via a play-free ball screw drive 203. Again, the Y drive motors 202 can be separately position-controlled or operated in master-slave mode. In order to dampen vibrations along the Y direction, each linear guide 201 is optionally assigned a vibration damper (not shown in drawings), which can be configured according to Swiss patent application 1023/18 dated Aug. 24, 2018.

Each of the two linear guides 201 is assigned a Y linear measuring system 230. Each of these Y linear measuring systems comprises a measuring head 231 mounted on the outside of the Y slide 200 and a linear scale 232 mounted on the machine bed 100. The measuring head 231 carries out its position measurement in a plane E3 that is perpendicular to the Y direction (i.e. a plane normal to the Y axis) and contains the C axis. This plane E3 is particularly suitable for characterizing the position of the C axis relative to the machine bed 100 with respect to the Y direction and is therefore also referred to as the C reference plane.

As with the Z axis, all relevant components of the Y axis are identical in pairs and arranged symmetrically to the center plane E1, in particular the Y linear guides 201, the Y drive motors 202, the ball screw drives 203, the vibration dampers and the Y linear measuring systems 230.

### Meshing Device

For the hard fine machining of pre-toothed workpieces, a meshing device 410 is arranged on the X slide 310, which is configured to determine the angular position of the tooth gaps of the workpiece 220 with respect to the C axis without contact, so that the tool 330 can be brought into engagement with a pre-toothed workpiece 220 without collision. For this purpose, the meshing device 410 has a meshing probe 411 arranged at its lower end, which measures the tooth gaps in a known manner. The single meshing device 410 can be attached to either of the two cheeks 313 of the X slide 310. For this purpose, the two cheeks have mounting surfaces 412 with corresponding holes on the front side (see FIG. 2).

### Measuring Bridge

In FIG. 3, an optical measuring bridge 420 can be seen particularly well, which is mounted on the Y slide 200 and is used to measure the tool 330. In particular, the measuring bridge can be a laser measuring bridge with laser and photodetector. The measuring bridge 420 can be located either to the left or right of the center plane E1 on the workpiece carrier 200. For this purpose, corresponding mounting surfaces 421 with corresponding holes are provided on the Y slide 200 to the left and right of the center plane E1 (see FIG. 4). The tool can be measured in particular according to WO 2019/115332 A1.

### Tool Changer

FIG. 5 schematically shows a changing device 430 for the automatic changing of the tool. The changing device is attached to the machine bed 100 and can also be arranged either to the left or right of the center plane E1. For this purpose, corresponding mounting surfaces 431 and holes are provided on the machine bed 100.

### Workpiece Loader

As shown in FIG. 5, the machine is optionally equipped with a workpiece loader 440. The workpiece loader can remove a finished workpiece 220 from the workpiece spindle 210 and replace it with a blank to be machined, or it can exchange the workpiece clamping device. Depending on the customer's requirements, the workpiece loader 440 can be located to the left or right of the center plane E1.

To avoid collisions with the meshing device 410, the measuring bridge 420 or the tool changer 430 during the workpiece change, these additional components are arranged either to the left or right of the center plane E1, depending on the position of the workpiece loader 440. The corresponding arrangement will be determined during the project planning phase of the machine according to the customer's requirements.

Alternatively, the workpiece loader can also be positioned at the front end of the machining area 130 in the center plane E1, as also indicated in FIG. 5. If desired, it is also possible to arrange the workpiece loader at the rear of the machine so that the loading and unloading process takes place through an opening in the vertical portion 120 of the machine bed. For this purpose, the chip conveyor 500 is arranged rotated by 180° relative to the arrangement of FIGS. 1 to 6, so that its rising section with the drive comes to rest at the front end of the machining area 130. Due to the limited accessibility, however, this arrangement of the workpiece loader is only useful in exceptional cases.

### Second Embodiment: Horizontal Workpiece Axis

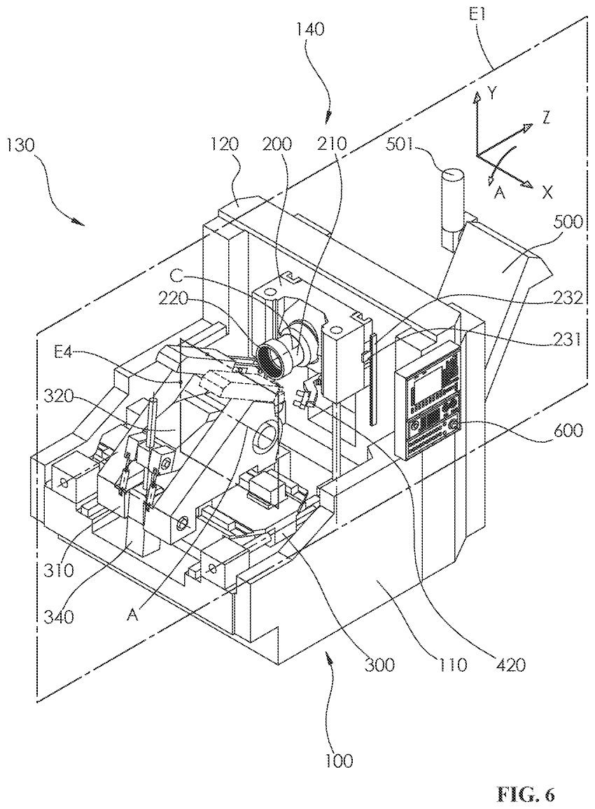

While the machine of the first embodiment has a vertically aligned workpiece axis C, it is also conceivable to align the workpiece axis C horizontally without deviating from the principles described above. This is illustrated in FIG. 6. Equal-acting parts carry the same reference signs as in FIGS. 1 to 5.

Again, the machine bed 100 has a horizontal portion 110 and a vertical portion 120. Unlike in the first embodiment, the Y slide 200, which serves as a workpiece carrier, can now be displaced vertically on the vertical portion 120, i.e. the Y direction is now vertical. Accordingly, the C axis now runs horizontally. As before, the C axis runs in a center plane E1, and the Y slide 200 on the machine bed 100 is guided symmetrically to the center plane by two linear guides. The Z slide 300 can now be moved horizontally on the horizontal portion 110 of the machine bed 100 parallel to the C axis, i.e. the Z direction is now horizontal. The Z slide is again guided symmetrically to the center plane by two linear guides. The X slide 310, which serves as the tool carrier, is arranged on the Z slide 300 as in the first embodiment. It is constructed in the same way as in the first embodiment.

### Method of Operation

A method of operation for a machine according to the first embodiment (FIGS. 1 to 5) is now discussed.

In order to machine a workpiece blank, the Y slide 200 is first brought into a workpiece change position against the Y direction, the workpiece change position being illustrated in FIGS. 1 to 3. In this position, the workpiece loader 440 is used to remove the last finished workpiece 220 from the workpiece spindle 210 and the workpiece blank to be machined is placed on the workpiece spindle 210 and clamped. Then the Y slide 200 is moved along the Y direction to a machining position as illustrated in FIG. 5.

In the case of hard fine machining, the Z slide 300 and the X slide 310 are now positioned in such a way that the meshing device can measure the tooth gaps of the blank. In this way, the angular position of the tooth gaps of the blank is determined.

The Z slide 300 and the X slide 310 are then brought into a position in which the tool 330 meshes with the blank, as illustrated in FIG. 5. The B axis extends offset either to the left or to the right of the center plane of the machine tool, depending on the helix angles of the workpiece and the tool. Now the generating machining of the blank is carried out in the usual way. The tool 330 and the workpiece 220 rotate at a fixed ratio of their rotational speeds. This positive coupling is carried out electronically by the machine controller.

If desired, the tool is measured with the aid of the measuring bridge 420. In the case of a gear skiving tool, this can be done, for example, in a manner described in WO 2019/115332 A1. Such measurement can be carried out, for example, after each tool change and periodically after a certain number of machining operations.

If the tool has to be changed, this is preferably done with the changing device 430.

### Modifications

It goes without saying that the invention is not limited to the embodiments described above, but that various modifications are possible without leaving the scope of the invention.

For example, in the first embodiment, the Y direction can also be at an angle to the horizontal, but still parallel to the center plane E1. This may be advantageous under certain circumstances for design reasons or for reasons of loading and unloading the workpiece spindle. The Z direction does not necessarily have to be parallel to the C axis as long as this direction also remains parallel to the center plane E1. The symmetry of the machine is not destroyed by such modifications.

A variety of other modifications are possible. In particular, the machine can also be used for other generating machining processes than gear skiving. In this case, the tools that are typical for the respective process, preferably gearwheel-shaped tools, are used. Combinations of two or more machining processes can also be carried out successively on the same machine. It is conceivable, for example, that a workpiece is first processed by gear skiving and then by gear honing.

In addition to hard fine machining, the machine can also be used for soft machining, whereby only the meshing probe must be put out of operation and tools typical of the soft machining process are used.

1. A machine tool for the machining of rotary parts with groove-shaped profiles by a generating method, the machine tool comprising:
a machine bed;
a Y slide linearly displaceable along a Y direction relative to the machine bed;
a workpiece spindle arranged on the Y slide and configured to clamp a workpiece thereon and to drive it to rotate about a workpiece axis (C), the workpiece axis (C) extending transversely to the Y direction;
a Z slide arranged on the machine bed and linearly displaceable along a Z direction relative to the machine bed, the Z direction running parallel to a center plane defined by the Y direction and the workpiece axis, and the Z direction extending at an angle of less than 45° to the workpiece axis;
an X slide arranged on the Z slide and linearly displaceable along an X direction relative to the Z slide, the X direction being perpendicular to the center plane; and
a tool spindle configured to drive a generating machining tool about a tool axis,
the tool spindle being arranged on the X slide and being pivotable relative to the X slide about a first swivel axis.

2. The machine tool according to claim 1,
wherein the first swivel axis is perpendicular to the center plane,
wherein the tool axis is perpendicular to the first swivel axis, and
wherein the tool spindle is pivotable about the first swivel axis in a swivel plane that extends parallel to the center plane.

3. The machine tool according to claim 2, wherein the machine tool comprises two first swivel bearings for pivotably supporting the tool spindle on the X slide about the first swivel axis, wherein the two first swivel bearings are arranged on both sides of the tool spindle with respect to the swivel plane.

4. The machine tool according to claim 2, comprising an adjustment mechanism for adjusting the orientation of the tool spindle relative to the X slide,
wherein the adjustment mechanism is connected to the X slide so as to be pivotable about a second swivel axis, the second swivel axis extending parallel to and spaced apart from the first swivel axis-(A), and
wherein the adjustment mechanism is connected to the tool spindle so as to be pivotable about a third swivel axis, the third swivel axis extending parallel to and spaced apart from the first swivel axis and the second swivel axis.

5. The machine tool according to claim 4,
wherein the machine tool comprises two second swivel bearings for pivotably supporting the adjustment mechanism on the X slide about the second swivel axis, wherein the two second swivel bearings are arranged on both sides of the swivel plane, and/or
wherein the machine tool comprises two third swivel bearings for pivotably supporting the adjustment mechanism on the tool spindle about the third swivel axis, wherein the two third swivel bearings are arranged on both sides of the swivel plane.

6. The machine tool according to claim 4, wherein the adjustment mechanism comprises:
an A-drive motor, which is mounted on the X slide so as to be pivotable about the second swivel axis
a threaded spindle drivable by the A-drive motor to rotate about a threaded spindle axis extending perpendicular to the first swivel axis, the threaded spindle axis extending in the swivel plane; and
a spindle nut which is in engagement with the threaded spindle (342) and is connected to the tool spindle (320) so as to be pivotable about the third swivel axis (A″).

7. The machine tool according to claim 6, comprising:
a first angle measuring device configured to determine a rotation angle of the threaded spindle about the threaded spindle axis; and/or
a second angle measuring device configured to directly determine a swivel angle of the tool spindle about the first swivel axis relative to the X slide.

8. The machine tool according to claim 4,
wherein the tool spindle has an end that faces the tool and an end that faces away from the tool,
wherein a generating machining tool is clamped on the tool spindle at the end that faces the tool, the generating machining tool defining a tool reference plane, the tool reference plane extending perpendicularly to the tool axis,
wherein the first swivel axis intersects the tool axis between the end of the tool spindle that faces the tool and the end that faces away from the tool,
wherein the first swivel axis and the tool reference plane extend at a first distance from each other,
wherein the first swivel axis and the third swivel axis extend at a second distance from each other, and
wherein the second distance and the first distance have a ratio greater than 1.

9. The machine tool according to claim 1, comprising:
at least one vibration damper acting between the tool spindle and the X slide in order to damp vibrations of the tool spindle about the first swivel axis.

10. The machine tool according to claim 1,
wherein the tool spindle is pivotable relative to the X slide about the first swivel axis in such a manner that an axis crossing angle between the tool axis and the workpiece axis is able to takes on negative and positive values between a smallest negative value and a maximum positive value, and
wherein the maximum positive value of the axis crossing angle is greater than a magnitude of the smallest negative value.

11. The machine tool according to claim 1, wherein the workpiece axis runs vertical in space.

12. The machine tool according to claim 1,
wherein the machine tool comprises two mutually parallel Z linear guides on which the Z slide is guided along the Z direction relative to the machine bed, the Z linear guides extending parallel to the Z direction and being arranged on both sides of the center plane,
wherein the machine tool comprises two Z-drives for moving the Z slide along the Z direction relative to the machine bed, and
wherein each of the Z-drives is assigned to one of the Z linear guides.

13. The machine tool according to claim 12, comprising at least one, preferably two Z linear measuring systems, each of the Z linear measuring systems comprising a measuring head mounted on the Z slide and a linear scale mounted on the machine bed, and wherein the measuring heads of the Z linear measuring systems are arranged such that they carry out a position measurement in an A-reference plane which is perpendicular to the Z direction and contains the first swivel axis.

14. The machine tool according to claim 1,
wherein the machine tool comprises two parallel Y linear guides which extend parallel to the Y direction, are arranged on both sides of the center plane and on which the Y slide is guided along the Y direction relative to the machine bed,
wherein the machine tool comprises two Y drives for moving the Y slide along the Y direction relative to the machine bed, and
wherein in each case one of the Y drives is assigned to each of the Y linear guides.

15. The machine tool according to claim 14, comprising at least one Y linear measuring system, each Y linear measuring systems comprising a measuring head mounted on the Y slide and a linear scale mounted on the machine bed, and wherein the measuring heads of the Y linear measuring systems are arranged in such a way that they perform a position measurement in a C reference plane which is perpendicular to the Y direction and contains the workpiece axis.

16. The machine tool according to claim 1,
wherein the machine tool comprises at least one of the following additional components:
a meshing device for determining a position of tooth gaps of the workpiece;
an optical measuring bridge for measuring the workpiece and/or the tool; and
a tool changing device for changing the tool, and
wherein the machine tool has two alternative fastening structures for each of the additional components, the alternative fastening structures being arranged on both sides of the center plane.

17. The machine tool according to claim 1,
wherein the machine tool comprises a chip conveyor, and
wherein the machine bed has a central opening to allow discharge of chips onto the chip conveyor.

18. The machine tool according to claim 1, comprising a controller configured to establish a positive coupling between a rotation of the generating machining tool and a rotation of the workpiece.

19. A method of machining a workpiece with a machine tool according to claim 1, the method comprising:
bringing a generating machining tool clamped on the tool spindle into engagement with the workpiece while the workpiece is clamped on the workpiece spindle, wherein the engagement takes place in an arrangement of the generating machining tool relative to the workpiece in which the tool axis extends offset to the center plane of the machine tool; and
carrying out a generating machining operation on the workpiece with the machine tool.

20. The method according to claim 19, wherein the generating machining tool is gear-shaped.

21. The method according to claim 19, wherein the generating machining tool is a gear skiving tool.

22. The machine tool according to claim 1, wherein the workpiece axis extends perpendicularly to the Y direction.

23. The machine tool according to claim 1, wherein the Z direction extends parallel to the workpiece axis.

24. The machine tool according to claim 2, wherein the first swivel axis intersects the tool axis.

25. The machine tool according to claim 3, wherein the two first swivel bearings are equidistant from the swivel plane.

26. The machine tool according to claim 8, wherein the generating machining tool is gear-shaped.

27. The machine tool according to claim 8, wherein the generating machining tool is a gear skiving tool.

28. The machine tool according to claim 8, wherein the generating machining tool comprises a plurality of cutting edges arranged at a distal end of the tool, and wherein the tool reference plane extends through the cutting edges of the tool.
